(19) United States
(12) Patent Application Publication
(10) Pub. No.: US 2024/0394816 A1
(43) Pub. Date: Nov. 28, 2024

(54) SYSTEM AND METHOD TO DETERMINE COMPETITIVE INTEREST IN REAL ESTATE

(71) Applicant: Honeywell International Inc., Charlotte, NC (US)

(72) Inventors: Adam Kuenzi, Silverton, OR (US); JW Beatty, Molalla, OR (US)

(21) Appl. No.: 18/793,687

(22) Filed: Aug. 2, 2024

Related U.S. Application Data
(63) Continuation of application No. 16/017,366, filed on Jun. 25, 2018.
(60) Provisional application No. 62/525,430, filed on Jun. 27, 2017.

(51) Int. Cl. G06Q 50/16; G06Q 30/0201; G06Q 30/0601

(52) U.S. Cl. CPC G06Q 50/167; G06Q 30/0201; G06Q 30/0611; G06Q 30/0625

(57) ABSTRACT

A method for determining competitive interest for a subject property includes receiving data regarding a subject property from a handheld device operating a competitive interest application; determining a set of buyers based on the subject property; classifying the set of buyers; determining at least one comparable property based on the subject property; communicating an output that compares a competitive interest in the subject property in response to the set of buyers and the at least one comparable property.

This is a continuation of co-pending U.S. patent application Ser. No. 16/017,366, filed Jun. 25, 2018, and entitled “SYSTEM AND METHOD TO DETERMINE COMPETITIVE INTEREST IN REAL ESTATE”, which claims priority to U.S. Provisional Application Ser. No. 62/525,430, filed Jun. 27, 2017, both of which are incorporated herein by reference.

### BACKGROUND

The present disclosure relates generally to a real estate communication system, and more particularly, to a system and method to determine competitive interest in a real estate property to facilitate sales.

In the real estate industry, a home buyer typically has no knowledge of how many other buyers may also be looking at a particular home. A real estate agent may provide some information but typically has minimal knowledge of the seriousness of other potential home buyers.

### SUMMARY

A method for determining competitive interest in a subject property, according to one disclosed non-limiting embodiment of the present disclosure includes receiving data regarding a subject property from a competitive interest application; determining a set of buyers based on the subject property; determining at least one comparable property based on the subject property; determining an output that compares a competitive interest in the subject property based on the set of buyers and the at least one comparable property; and communicating the output to the competitive interest application.

A further aspect of the present disclosure includes classifying the set of buyers by classifying at least a portion of the set of buyers as interested buyers.

A further aspect of the present disclosure includes that the interested buyers are buyers who have viewed the subject property.

A further aspect of the present disclosure includes classifying the set of buyers by classifying at least a portion of the set of buyers as serious buyers.

A further aspect of the present disclosure includes that the serious buyers are buyers who have attended a showing of any property in a listing database accessible through a real estate application.

A further aspect of the present disclosure includes classifying the set of buyers by classifying at least a portion of the set of buyers as competitive buyers.

A further aspect of the present disclosure includes that the competitive buyers are buyers who have attended a showing of the subject property.

A further aspect of the present disclosure includes classifying the set of buyers by classifying at least a portion of the set of buyers as interested buyers, the interested buyers are buyers who have viewed the subject property in a real estate application.

A further aspect of the present disclosure includes classifying at least a portion of the buyers as serious buyers, wherein the serious buyers are buyers who have attended a showing of any property in a listing database accessible through a real estate application.

A further aspect of the present disclosure includes classifying at least a portion of the buyers as competitive buyers, wherein the competitive buyers are buyers who have attended a showing of the subject property.

A further aspect of the present disclosure includes classifying the set of buyers by classifying at least a portion of the set of buyers as interested buyers, the interested buyers are buyers who have viewed the subject property in a real estate application, at least a portion of the interested buyers as serious buyers, wherein the serious buyers are buyers who have attended a showing of any property in a listing database accessible through a real estate application, and at least a portion of the serious buyers as competitive buyers, wherein the competitive buyers are buyers who have attended a showing of the subject property.

A further aspect of the present disclosure includes comparing a feedback rating on the subject property and a feedback rating on the at least one comparable property.

A further aspect of the present disclosure includes a number of comparative properties and a ratio of the number of comparative properties to competitive buyers.

A system for determining competitive interest in a subject property, according to one disclosed non-limiting embodiment of the present disclosure includes a buyer server hosting a buyer application program interface that receives a subject property; a buyer storage system in communication with the buyer server, the buyer storage system including a database that stores buyer feedback regarding a real estate property; and a listing recommendation server hosting an analytics software application that determines a set of buyers based on the subject property, and compares a feedback rating on the subject property and a feedback rating on at least one comparable property to determine a competitive interest in the subject property for communication to a competitive interest application.

A further aspect of the present disclosure includes that the analytics software application determines the competitive interest in response to the set of buyers and the at least one comparable property for communication to the competitive interest application.

A further aspect of the present disclosure includes that the analytics software application determines the competitive interest a number of comparative properties and a ratio of the number of comparative properties to competitive buyers for communication to the competitive interest application.

A further aspect of the present disclosure includes a handheld device running the competitive interest application.

A handheld device according to one disclosed non-limiting embodiment of the present disclosure includes a power supply; a memory to store executable instructions for operation of a competitive interest application; a processor in communication with the memory and the power supply, the processor operable to execute the executable instructions to receive data regarding a subject property, a set of buyers, and at least one comparable property to the subject property; and a display in communication with the processor, the display configured for displaying a competitive interest in the subject property as a comparison between a feedback rating on the at least one comparable property and a feedback rating for the subject property for the set of buyers.

A further aspect of the present disclosure includes wherein the competitive interest in the subject property is a ratio of a number of the comparable properties to a number of competitive buyers.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic system diagram of a real estate application system.

FIG. 2 is a schematic diagram of a handheld device.

FIG. 3 is a flowchart of a method to provide communication for a real estate transaction with the system of FIG. 1.

FIG. 4 is a screenshot of a property listing view from the real estate application.

FIG. 5 is a schematic system diagram of a portion of the real estate application system.

FIG. 6 is a flowchart of a method to determine competitive interest using a competitive interest application.

FIG. 7 is a screenshot of an output from the competitive interest application.

FIG. 8 is another screenshot of an output from the competitive interest application.

### DETAILED DESCRIPTION

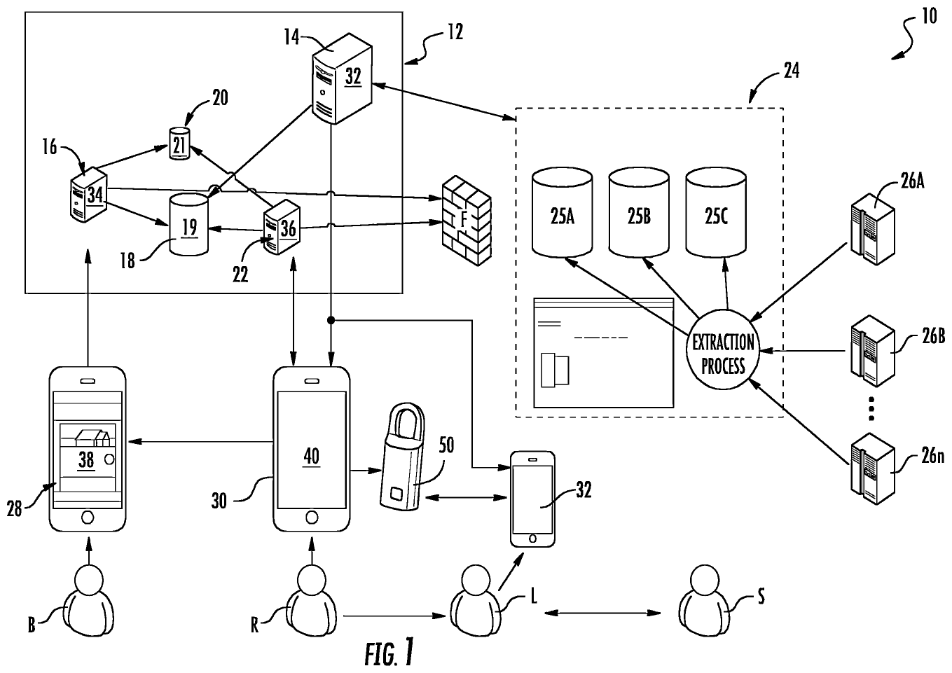

FIG. 1 schematically illustrates a system 10 to facilitate communication for real estate transactions. A property buyer “B” is typically represented by a showing agent “R” while a property seller “S” is typically represented by a listing agent “L.” The listing agent “L” communicates with the buyer “B” only indirectly, such as by communication with the showing agent “R” who then communicates information with the buyer “B.” Although only particular agents are referred to in the illustrated embodiments, the functions of such personnel may be otherwise assigned or rearranged. For example, the listing agent “L” may be a senior person in an agency who utilizes a seller's assistant. The showing agent “R” may similarly utilize a showing assistant. As is discussed below, the prospective buyer “B” may wish to obtain input from third parties such as family, friends, and/or others.

The system 10 generally includes a subsystem 12 that may be controlled by a single owner. The subsystem 12 generally includes a listing recommendation server 14, a buyer server 16, a buyer storage system 18, a log storage system 20, and an electronic key server 22. The listing recommendation server 14 communicates with the buyer storage system 18, the log storage system 20, and a storage system 24. The buyer storage system 18 includes a database 19 that stores, for example, feedback created by the buyer “B” (e.g., buyer feedback, third party feedback, etc.). The log storage system 20 includes a database 21 that collects activity data associated with the property showings.

The storage system 24 may include, but not be limited to, a database for managing key holders 25A, a security database 25B that hosts security protocols, and a listing database 25C that stores extracted property data from external databases 26A, 26B, 26N. The storage system 24 communicates with the external databases 26A-26N such as the Real Estate Transaction Standard (RETS) framework that stores MLS data. Communication between the various servers may include internet protocols or the like. The MLS data may include information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The national association of realtors refers to RETS as a “common language.”

A multiple of handheld devices 28, 30, 32, may communicate with the subsystem 12. For example, the handheld devices 28, 30, 32, may be a smartphone, tablet, or other mobile device of the respective individual. Handheld device 28 is used by the potential buyer “B,” handheld device 30 is used by the showing agent “R,” and handheld device 32 is used by the listing agent “L. Various other handheld devices such as those used by the third parties “T” may also be in communication with the subsystem 12 either directly or through communication with the handheld devices 28, 30, 32, as an intermediary.

Information is accessible by the listing agent “L” through the subsystem 12 so that the listing agent “L” can, for example, generate reports for their seller “S,” send updates about a particular listing to showing agents “R”, or provide feedback from a buyer “B” to their seller “S.” The subsystem 12 may also obtain information from a Real Estate Transaction Standard (RETS) framework that stores MLS data. The subsystem 12 may also obtain information generated by an electronic key box 50 that occurs as a consequence of the showing, such as number of times shown, time spent at the subject property for each showing, return showings, etc. The subsystem 12 may also be used by the listing agents “L” to receive automatic notification (e.g., email notices) when a showing occurs at their listings. The subsystem 12 may also be used by the buyer “B” as a repository for information (e.g., details of each property the buyer has viewed, feedback on the properties, etc.). The seller “S” can also receive feedback from the buyer “B” either directly from the subsystem 12, or through communications with the listing agent “L” who communicates with the subsystem 12.

The listing recommendation server 14 hosts, for example, at least an analytics software application 32 that compiles and runs analytics against buyer ratings from the buyer data storage 18 and MLS listing data from the storage system 24. The buyer server 16 hosts a buyer application program interface (API) 34, and the electronic key server 22 hosts an electronic key API 36. An application program interface (API) may include a set of routines, protocols, and/or tools for building software applications. The API specifies how software components should interact. APIs are used when programming graphical user interface (GUI) components. A server-side web API is a programmatic interface with one or more publicly exposed endpoints to a defined request—response message system.

The listing recommendation server 14 may communicate with a real estate application 38 on the handheld device 28 through the buyer API 34. An agent application 40 on the handheld device 30 may communicate with the listing recommendation server 14 and the electronic key server 22. The buyer API 34 and the electronic key API 36 may also communicate with other external systems through a firewall “F.”

The real estate application 38 may be a mobile application on the handheld device 28 that may be used by the buyer “B” to rate the properties they have seen and, as will be further described below, receive third party feedback from third parties “T” based on the buyer “B” feedback. The real estate application 38 communicates with the buyer storage system 18 through the buyer API 34 which then stores the feedback, ratings, and notes taken by the property buyer in the database 19 of the buyer storage system 18.

The agent application 40 may be a mobile application on the handheld device 30 that may be used by the showing agent “R” to access the electronic key boxes 50 via a short distance communication standard (e.g., Bluetooth). Alternatively, or in addition, the electronic key boxes 50 may be connected (e.g., cellular) directly to the listing recommendation server 14. The electronic key API 36 of the electronic key server 22 communicates with the agent application 40 to sync activity information from the electronic key boxes 50 to the electronic key API 36 (e.g., accessed key boxes, update the count of proprietary keys generated for that particular property, create a timestamp indicating that lockbox is opened), and showing notifications (e.g., to an associated showing agent “R”).

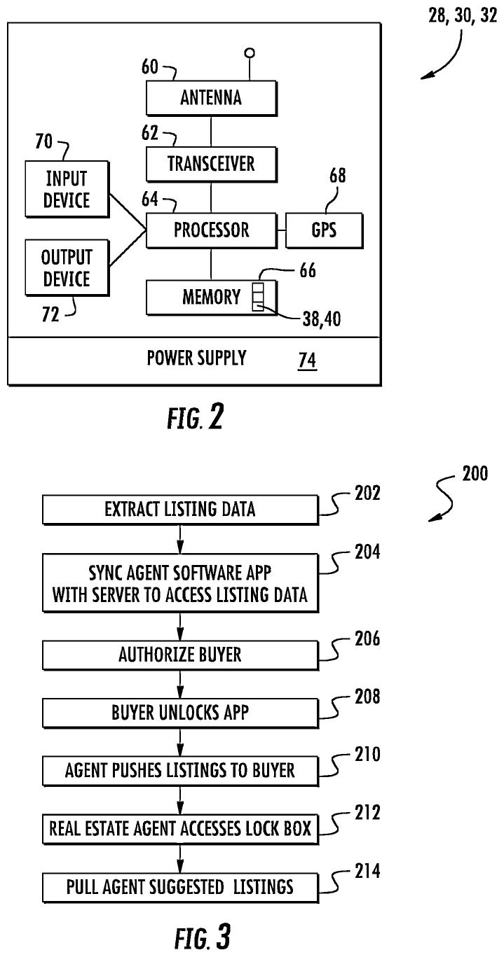

With reference to FIG. 2, each handheld device 28, 30, 32, generally includes a handheld device antenna 60, a handheld device transceiver 62, a handheld device processor 64, a handheld device memory 66, a GPS module 68, an input device 70, a display 72, and a handheld device power supply 74. The handheld device processor 64 may be any type of microprocessor having desired performance characteristics. The handheld device memory 66 may include any type of computer readable medium that stores the data and executable instructions described herein below. The executable instructions may be stored or organized in any manner and at any level of abstraction, such as in connection with one or more applications, processes, routines, procedures, methods, etc.

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to selectively extract (202) data such as MLS data from the external data servers 26A-26N (FIG. 1) through the listing recommendation server 14. Next, the agent application 40 syncs (204) with the listing recommendation server 14 and pulls MLS data for desired property listings of interest to the buyer “B” as, for example, selected by the showing agent “R.” This may be performed through an automated sync through the agent application 40. The showing agent “R” may also perform a manual sync to obtain the MLS data.

Through the agent application 40, the showing agent “R” can then authorize (206) the property buyer “B” to access the desired property listings of interest to the buyer “B.” Through the agent application 40, the showing agent “R” may, for example, authorizes the buyer “B” through input of buyer identification information (e.g., buyer name and email address.) The buyer identification information is then communicated to the listing recommendation server 14 so that the listing recommendation server 14 communicates the buyer “B” (e.g., via email, text message or other communication to provide a link to an app store) with a code to unlock (208) the real estate application 38. The buyer “B” is then authorized to download the real estate application 38 and the desired property listings of interest to the buyer “B,” to maintain the value of the showing agent “R” in the real estate transaction. Alternatively, the buyer “B” already has the real estate application 38 and the desired property listings of interest to the buyer “B” are readily received.

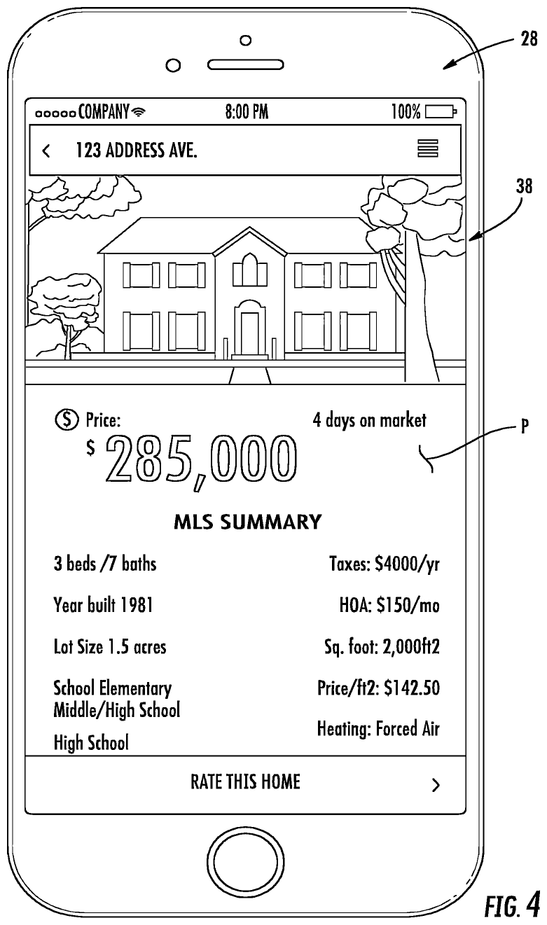

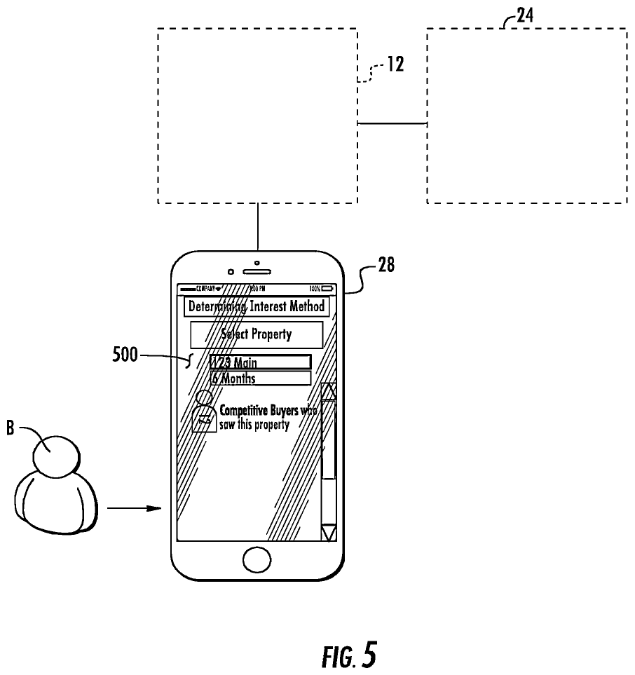

Through the agent application 40, the showing agent “R” can continue to push (210) property listings to the real estate application 38. Access may be provided for one or more properties by a showing code, or other information that unlocks one or more modules in the real estate application 38. The modules may include features or other aspects such as a competitive interest application 500 (FIG. 5) that are particular tailored to certain parties in the real estate transaction. The showing agent “R” is able to selectively push the desired property listings of interest to the buyer “B” (one example property listing illustrated by screenshot “P”; FIG. 4) through the subsystem 12 to be viewable within the real estate application 38. The showing agent “R” also uses the agent application 40 to operate the electronic key box 50 to access the property for showing to the buyer “B.”

With reference to FIG. 5, in addition to the features discussed above, the buyer “B” can utilize a competitive interest application 500 on their handheld device 28 to forming a buying strategy for a subject property. The competitive interest application 500 may be a separate application and/or a portion of the real estate application 38.

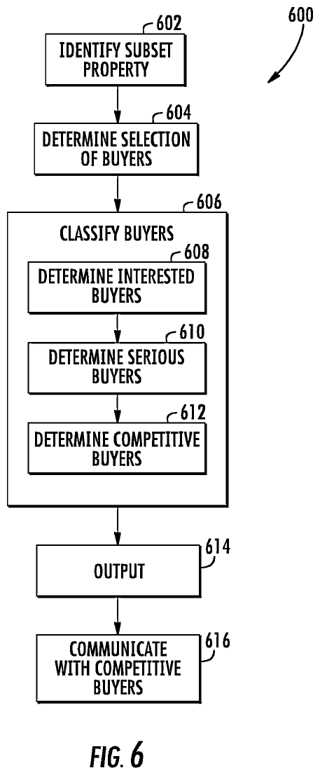

With reference to FIG. 6, a method 600 for determining competitive interest utilizing the competitive interest application 500 is illustrated in terms of functional block diagrams.

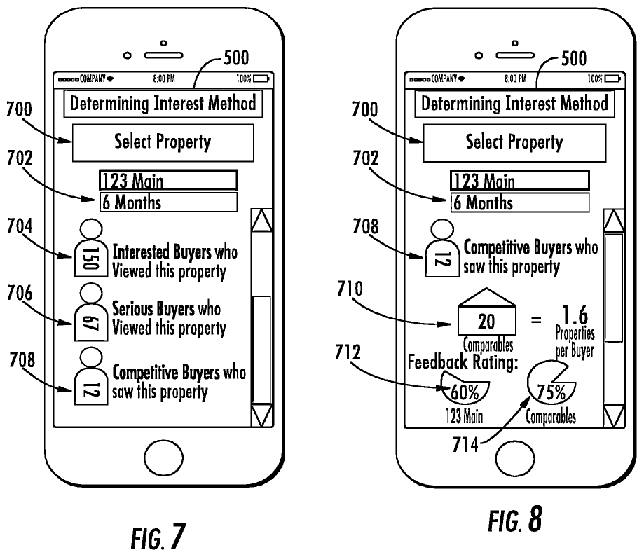

Initially, a user utilizes the competitive interest application 500 to identify (602) the subject property (FIG. 7; 700). The competitive interest application 500 communicates with the listing recommendation server 14 to obtain historical MLS data, data from the electronic key server 22, and feedback data from the buyer database system 18 for the subject property (FIG. 1). The data may be selected over a predetermined time period (e.g., 6 months; FIG. 7, 702).

Next, the competitive interest application 500 determines (604) a set of buyers based on the subject property. The set of buyers may be determined by the listing recommendation server 14 which communicates with the buyer database system 18 to determine buyers who have accessed the subject property. The listing recommendation server 14 may also communicate with the electronic key server 22 and/or other databases to identify buyers who have accessed the subject property.

The set of buyers based on the subject property are then classified (606).

From the set of buyers based on the subject property, the competitive interest application 500 determines (608) the number of interested buyers (FIG. 7, 704). Alternatively, the number of interested buyers may be determined by the subsystem 12. Interested buyers are ones who have viewed the subject property. The interested buyer may be a prospective buyer who has viewed the subject property only in the real estate application 38, a website or other electronic access system.

From the classified buyers, the competitive interest application 500 determines (610) the number of serious buyers (FIG. 7, 706). Serious buyers are ones who have actually attended a showing at any property in the listing database 25C. Serious buyers may have previously been considered interested buyers.

From the classified buyers, the competitive interest application 500 determines (612) the number of competitive buyers (FIG. 7 and FIG. 8, 708). Competitive buyers are ones who actually visited the subject property and/or a comparable to the subject property. Competitive buyers may have previously been considered serious and/or interested buyers.

Next, an output (614) is determined from the classified buyers. In one embodiment, a ratio of competitive buyers to comparable properties is determined (FIG. 8, 710). Specific filters may be utilized as search filters for comparable properties (e.g., area, price, class, status, bedrooms, bathrooms, garage, fireplaces, basement, etc.) The competitive interest application 500 determines the number of comparable properties from the listing recommendation server 14 based on the selected filters. In one example, the ratio may be calculated by dividing the number of competitive buyers by the number of comparable properties. The output can display this ratio as a number or in graphical form. The output can also display the number of comparable properties. A buyer or seller can determine from this number how competitive the market is for the selected property. If the resulting value of the ratio is small, it can indicate that there are few buyers looking at this segment of homes. If the resulting value is large it indicates there are many buyers and therefore more competition to buy homes of the same type as the selected property. Alternatively, the ratio may be inverted to indicate the number of properties per buyer. In the event that a resulting ratio is very small or very large it may be advantageous to use one form or the other dynamically so that the resulting ratio is a reasonably sized number that a person can grasp. For example, if there are 100 buyers for 1 property, it may be more intuitive to see a number 100 for buyers to comparables than to see 0.01 properties per buyer. Choosing which form of the ratio to view could be automatic or may be selectable by the user of the application in a settings menu, for example.

In another embodiment, an overall feedback rating from the competitive buyers' ratings on the subject property is determined (FIG. 8, 712). That is, the overall feedback rating may be a rating determined by taking an average of all the competitive buyers' feedback ratings for the selected property 700 during the identified time frame 702. Further, a similar calculation can be made for an average of all the competitive buyers' feedback ratings for comparable properties to the selected property. The output may then be the overall feedback rating for the subject property (e.g., 60%; FIG. 8, 712) as compared to an average feedback rating for the comparable properties (e.g., 75%; FIG. 8, 714). The overall feedback rating for the subject property and the competitive buyers' feedback ratings on the comparable properties may be displayed graphically (e.g., as a pie chart, or a number of stars) or numerically (e.g. as a percentage or a number). A buyer or seller can then compare these two average ratings together, to determine if the competitive buyers rate the selected property higher or lower than comparable properties.

In another embodiment, a number of showings for each of the comparable properties may be determined from the historical data in the listing recommendation server 14, parsed into the selected period of time 702 (e.g., a week) then averaged. The resulting number is the average number of showings for a comparable property during this time period. A similar calculation can be made for the selected property. The output can display these numbers of showings for the selected and comparable properties. A buyer or seller can then compare the numbers to determine if the selected property is being shown more or less times than the comparable properties during the selected time period.

In addition, the competitive interest application 500, through the listing recommendation server 14 and the buyer database system 18, may communicate (616) with the determined competitive buyers (e.g., via emailed questions as to seriousness with regard to the subject property). The communication may be used to refine the interests (e.g., will/will not put in an offer) and/or obtain particular feedback (e.g., the kitchen counters need to be replaced).

The competitive interest application 500 allows the buyer “B” to strategize their buying position whereas if the seller “S” utilizes the competitive interest application 500 for their own property they can get a view of how their property is ranking against others and strategize their selling activity to do things to attract more buyers (e.g. drop price, advertise more, etc.).

“Server” conveys its customary meaning and further includes a corporate datacenter that provides service and/or data connection, e.g., to the handheld device and/or an electronic locking device. “Handheld device” refers to a portable electronic device that is at least configured to send messages to, and/or receive messages from the listing recommendation server 14 over a long-range wireless communication network, such as a SMS, wireless, or cellular network. Examples of handheld devices include, but are not limited to: a cell phone; a personal digital assistant (“PDA”); a portable computer configured to store and playback digital pictures, songs, and/or videos; and the like. In addition, the handheld device is typically also configured for short-range wireless communications.

The elements described and depicted herein, including in flow charts and block diagrams throughout the figures imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A method for determining competitive interest in a subject property, comprising:
receiving data regarding a subject property from a competitive interest application;
determining a set of buyers based on the subject property;
determining at least one comparable property based on the subject property;
determining an output that compares a competitive interest in the subject property based on the set of buyers and the at least one comparable property; and
communicating the output to the competitive interest application.
